(19) United States
(12) Patent Application Publication
(10) Pub. No.: US 2004/0120290 A1
(43) Pub. Date: Jun. 24, 2004

(54) Admission control in a wireless communication network

(76) Inventors: Mahesh A. Makhijani, San Diego, CA (US); Todd Ruth, Valley Center, CA (US); Alpaslan G. Savas, San Diego, CA (US)

Correspondence Address: COATS & BENNETT, PLLC, P O BOX 5, RALEIGH, NC, 27602, US

(21) Appl. No.: 10/328,833

(22) Filed: Dec. 24, 2002

(51) Int. Cl. H04B 7/216

(52) U.S. Cl. 370/335; 370/342; 370/230

(57) ABSTRACT

Admission control in a wireless communication network considers power and spreading code resources as part of its admission control operations. In an exemplary embodiment, an admission controller admits new users in a manner that balances forward link transmit power and spreading code usage. More generally, network admission control maintains a desired relationship between power and code use as new users are admitted. Such control increases forward link capacity by avoiding premature exhaustion of either power or code resources. Thus, in operation, the admission controller chooses either a power-efficient or a code-efficient configuration for admitting new users, depending on the relative availability of power and code resources. Such power and code resource assessment may consider a particular communication channel, e.g., a CDMA channel, in a particular radio service area, or may consider the relative power/code usage balance among channels in multiple service areas.

### BACKGROUND OF THE INVENTION

The present invention generally relates to admission control in a wireless communication network, and particularly relates to controlling user admissions in a manner that maintains a desired relationship between the usage of forward link power and spreading code resources.

In wireless communication networks that employ Code Division Multiple Access, a finite set of spreading codes provides the basis for generating separate information signals on a common CDMA carrier signal. For example, the information stream transmitted on the forward link by the network to a particular mobile station may be spread by the network transmitter using a specific Walsh code, denoted here as Wx. The mobile station recovers its intended information stream from the received CDMA carrier signal by despreading that signal using the same Walsh code, Wx. Because the set of spreading codes is finite, the number of individual streams that may be code-multiplexed onto the CDMA carrier is limited. In this sense, the set of spreading codes may be viewed as an exhaustible resource that establishes a limit on the number of mobile stations (users) that can be supported by a particular CDMA carrier signal.

Commonly, the size of the spreading code set is referred to as the “code space,” and expansion of the code space increases the number of users that can be simultaneously supported. Several techniques exist for expanding spreading code space. For example, where the spreading code set comprises sixty-four 64-length Walsh codes, using one or more of the 64-length Walsh codes to generate 128-length Walsh codes increases the number of available spreading codes. More specifically, each 64-length Walsh code can be used to form two 128-length Walsh codes. Thus, the code space theoretically can be doubled from 64 codes to 128 codes by using 128-length Walsh codes.

Another approach to code space expansion supplements the base set of spreading codes, which are chosen to be orthogonal to one another, i.e., the cross-correlation between any pair of codes within the set is zero, with one or more additional “quasi-orthogonal” spreading codes. (The actual cross-correlation between two signals spread with different base set codes is very often non-zero at the mobile station because of differing multipath time delays between the signals.) As might be guessed from the terminology, these quasi-orthogonal codes are not completely orthogonal with respect to every spreading code in the base set of spreading codes. Thus, adding a quasi-orthogonal code user causes a greater increase in Multi-User Interference (MUI) than would be caused by adding a base set code user under equivalent radio conditions.

The undesirably higher interference caused by the use of quasi-orthogonal codes highlights a general point regarding the expansion of code space. That is, the expansion of code space often is at the expense of increased forward link transmit power requirements. With quasi-orthogonal codes, the need for greater transmit power arises from the disproportionately increased MUI associated with adding a quasi-orthogonal code user. Forward link transmit power, like spreading codes, is a finite and therefore exhaustible resource that places an upper bound on the number of users that may be simultaneously supported by a given network transmitter.

Other methods for expanding code space incur transmit power penalties as well. For example, in wireless communication networks based on the IS-2000 standards (cdma2000), users may be admitted in any one of several available “radio configurations,” depending on current channel conditions, the user's compatibility with the various configurations, and the user's data rate needs. In the set of available configurations, Radio Configuration 3 (RC3) uses 64-length Walsh codes with 1-to-4 convolutional encoding, while Radio Configuration 4 (RC4) offers higher data rates through its use of 128-length Walsh codes and 1-to-2 convolutional encoding.

Two RC4 users can be admitted for each 64-length Walsh code, while only one RC3 user can be admitted per 64-length Walsh code. However, assuming equivalent radio conditions, a RC3 user requires less transmit power than a RC4 user because of the lowered data redundancy in RC4 encoding. In other words, RC4 users make more efficient use of the spreading code space, while RC3 users make more efficient use of the available transmit power.

From the above details, one sees that the manner in which a new user is admitted to the network for service influences the relative consumption of power and code resources consumed by that user. A new user may be admitted in a manner that is more power-efficient or more code-efficient. However, since the exhaustion of either transmit power or spreading codes results in the inability to admit additional users, failing to strike the appropriate balance between power and code use as new users are admitted to the network results in lowered overall capacity utilization efficiency.

Conventional admission control methods generally do not consider the balance allocated power versus allocated spreading codes as part of admission control. Further, because of changing channel conditions, the aggregate power required to serve the admitted users is always changing, which means the “balance point” between the optimal numbers of code-efficient versus power-efficient users is always changing. Ideally, then, admission control would dynamically track the relationship between power and code usage, and use that information in determining whether to admit a new user as a code or power-efficient user.

### SUMMARY OF THE INVENTION

The present invention comprises a method and apparatus for admission control in a wireless communication network. Exemplary admission control admits new users in a manner that tends to maintain a desired relationship between available transmit power resources and available spreading codes resources on the one or more CDMA channels considered by an admission controller. In general terms, the admission controller operates to maintain a desired power/code resource usage balance to maximize network capacity utilization as new users are admitted to the channel(s) for service. In an exemplary embodiment, the admission controller admits a mobile station either as a power-efficient user or as a code-efficient user based on the relative availabilities of power and code resources on a given CDMA channel or, possibly, on a set of two or more CDMA channels. In this manner, the admission controller selectively admits new users as power-efficient or code-efficient users to maintain a balanced usage of transmit power and spreading code resources.

In an exemplary embodiment, an admission controller resides in a Base Station Controller (BSC) and manages new user admissions at one or more Radio Base Stations (RBSs) associated with the BSC. Each RBS transmits at least one CDMA channel that is constrained by finite transmit power and spreading code resources, and the admission controller works to maintain a desired relationship between allocated power and allocated spreading codes as new users are admitted to the CDMA channel(s). In this context, the BSC may receive periodic availability reports from the RBSs such that admission control tracks changing operating conditions, or the BSC may query particular RBSs for power/code availability information as part of its admission control operations. In either case, admission control tracks changing operating conditions to dynamically manage user admissions so that neither resource is disproportionately consumed relative to the other.

For a particular CDMA channel, or for a group of such channels, proportional allocation of power resources and coding resources would ideally track a nominal allocation line. Thus, the admission controller in one embodiment assesses the relative availabilities of power and code resources for the channel or channels, and projects the resultant allocation balance if the user is admitted as a power-efficient or as a code-efficient user, and selects the admission configuration corresponding to the allocation that more closely matches the nominal allocation. Further, the admission controller may adjust the intercept value of the nominal allocation line to bias admission toward power-efficient or code-efficient admission depending on whether current operating conditions (radio channels, user service characteristics, etc.) make it “easier” or more desirable to consume more power resources than coding resources or vice versa.

In embodiments where two or more channels are considered in the admission control decision, such channels may be selected or grouped in a variety of ways. For example, the network may include preconfigured “neighborhood” information that identifies sets of CDMA channels in, for example, adjacent or contiguous service areas that might be expected to have some degree of handoff activity between them. Alternatively, or in combination with the preconfigured approach to channel neighborhoods, such neighborhoods may be defined based on the “active set” of pilot signals reported by the mobile station being admitted. The neighborhood of CDMA channels may be defined as those channels corresponding to the active set or corresponding to some subset thereof. Of course, more expansive neighborhood definitions may be used, such as neighborhoods based on the base station “neighbor lists” associated with pilots in the active set, or based on other definitions as needed or desired.

Where admission control considers more than one CDMA channel, admission control may be based on combined power/code allocations for a neighborhood of channels. A set of CDMA channels within the neighborhood of channels may be designated as “reference” channels. The set of reference channels, which includes at least one CDMA channel, may be, for example, the CDMA channel corresponding to the user's current service area, the set of channels on which service was requested, a favored subset of such channels, e.g., good pilot strength report, and so on. In a simplified case, the set of reference channels at least includes the channel associated with the admission request, i.e., the CDMA channel on which the mobile station's origination request was received.

Thus, even if the user is being admitted only to the reference channel, the decision to select power or code-efficient admission on that channel may be made based on the power/code resource usage across the neighborhood of channels. For example, while the reference channel's proportion of power-to-code usage may favor admission as a power-efficient user, power/code usage imbalances in neighboring cells may make code-efficient admission the better choice. The evaluation of neighborhood power/code resource usage further benefits soft-handoff admissions, where resources for serving the user are allocated on two or more CDMA channels.

First power/code allocations may be determined for the reference channel, and second power/code allocations determined for the remaining channels. These first and second allocation values may be weighted to reflect an expected or measured “system mobility” that reflects the extent to which admitted users move or may be expected to move between the different service areas corresponding to the neighborhood of channels. Thus, power/code allocations on the reference channel may be weighted more or less heavily than the power/code allocations for the remaining channels as a function of system mobility. Where mobility is low, the reference channel is more greatly emphasized, and where mobility is high, the remaining channels, which may correspond to neighboring service areas, for example, are more greatly emphasized.

Various other bases for admission control may be used in determining whether to admit a particular user as a power-efficient user or as a code-efficient user. For example, the projected power/code allocations for power-efficient and code-efficient admission may be computed and compared to a nominal allocation value, with the more favorable comparison determining the selected admission configuration. In still other embodiments, the admission controller might admit the user as a power-efficient user if power resources currently are scarce in comparison to coding resources or vice versa if coding resources are relatively scarce. These computational variations may consider single CDMA channels, or may include power/code allocation information from multiple CDMA channels. Further, the various approaches may be combined as needed or desired, or may be dynamically changed such that the admission controller uses different methods at different times. For example, the power/code resource usage may be implicitly considered by favoring power-efficient admission for users that are distant from their serving RBS(s), and code-efficient admission for users that are relatively close.

Regardless of the specific implementation, the present invention enables a wireless communication network to manage call admissions at one or more network transmitters, e.g., radio base stations, such that the forward link power and spreading code resources are proportionally consumed as mobile stations are admitted for service. Such operation avoids premature exhaustion of either resource and tends to balance the utilization of each resource, thereby increasing overall capacity utilization of one or more forward link transmission channels. Such operations may be performed based on a CMDA channel within a single service area, such as at a cell transmitter of a given RBS that will be used to support the admitted mobile station, or may be performed for one or more service areas. In the latter case, the relative availabilities of power and code resources of multiple CDMA channels are considered in making the admission control decision.

The present invention generally improves network capacity utilization by maintaining a desired relative usage of transmit power and spreading code resources. Such operation is not limited to a particular type of network and, indeed, offers operating advantages wherever network capacity is jointly constrained by finite power and spreading code resources. As such, the present invention finds exemplary application to IS-95, IS-2000, WCDMA, and various other types of wireless communication networks that offer opportunities for tailoring admission control toward power or coding efficiencies on a selective basis.

### BRIEF DESCRIPTION OF THE DRAWINGS

FIG. 1 is a diagram of an exemplary wireless communication network.

FIG. 2 is a diagram of exemplary Base Station Controller and Radio Base Station details.

FIG. 3 is an exemplary logic flow diagram for practicing the present invention.

FIG. 4 is a diagram of an exemplary nominal allocation line for power/code resources on one or more CDMA channels provided by the network of FIG. 1.

### DETAILED DESCRIPTION OF THE INVENTION

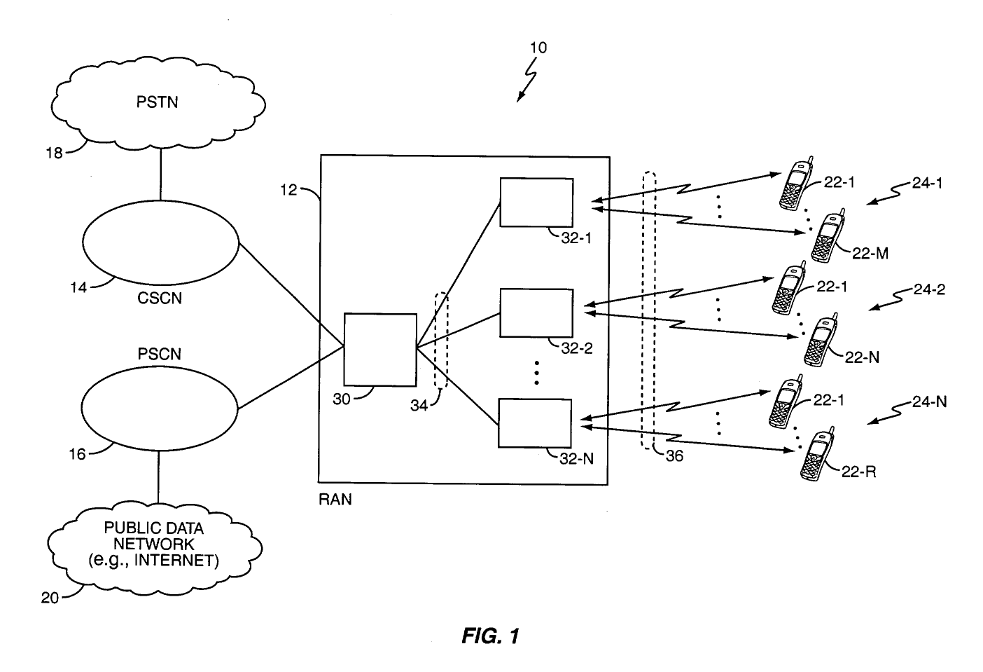

FIG. 1 is a diagram of an exemplary wireless communication network 10 in which the present invention may be practiced. In at least one exemplary embodiment, network 10 is configured in accordance with the IS-2000 standards (cmda2000), but the invention may be practiced in other network types. Thus, it should be understood that the present invention has applicability to Code Division Multiple Access networks in general and, more broadly, applicability to any network in which user admissions are constrained by the availability of power and coding resources, as will be detailed later herein.

An exemplary Radio Access Network (RAN) 12 is communicatively coupled to a Circuit Switched Core Network (CSCN) 14 and a Packet Switched Core Network (PSCN) 16, which are respectively coupled to the Public Switched Telephone Network (PSTN) 18 and one or more Public Data Networks (PDNs) 20, such as the Internet. Thus, in an exemplary configuration, network 10 supports both circuit-switched (voice and data fax) communications and packet-switched (emailing, media streaming, Web browsing, etc.) communications by communicatively coupling wireless communication devices, such as mobile stations 22 to both the PSTN 18 and the Internet 20. However, those skilled in the art will recognize that the present invention may be practiced in networks supporting only circuit-switched operations or those that support only packet-switched operations.

In an exemplary embodiment, the RAN 12 comprises one or more Base Station Controllers (BSCs) 30, each supporting one or more Radio Base Stations (RBSs) 32, e.g., 32-1 through 32-N. Typically, RBSs 32 are coupled to the supporting BSC 30 via one or more communication links 34, such as T1/E1 lines and/or microwave transceiver links. Regardless, RBSs 32 each have the capacity to support radio communication with many mobile stations 22, and in the illustration, the RBSs 32 are each shown as supporting a group 24 of mobile stations 22.

Thus, RBS 32-1 supports group 24-1 of mobile stations 22-1 through 22-M by transmitting data to them on one or more forward links on at least one CDMA channel signal and receiving data from them on one or more reverse links, such as dedicated traffic channel links. Each RBS 32 may transmit multiple CDMA channels, and a mobile station 22 in soft handoff on the forward link has radio links assigned from two or more CDMA channels, possibly from different RBSs 32.

Network 10 preferably provides radio coverage on a service area basis. As used herein, the term “cell” represents a defined area of radio coverage provided by network 10. Generally, each RBS 32 transmits at least one CDMA channel in each cell that it supports. As an example, assuming that RBS 32 operated with a single CDMA carrier frequency, “Carrier F1,” but supported three radio cells, Cell A, Cell B, and Cell C, the RBS 32 would provide, in an exemplary configuration, one CDMA channel for each cell. Thus, each CDMA channel may be thought of as the “intersection” of a given CDMA carrier signal with a defined service area. Of course, where the RBS 32 supports multiple CDMA carriers, it preferably but not necessarily transmits CDMA channel signals for all carriers frequencies within each cell.

Generally, each CDMA channel is allocated a finite amount of forward link transmission power and a base set of spreading codes. The instantaneous number of users that each channel can support depends on the current operating conditions, e.g., radio channel conditions and the types of user services being supported, but the maximum number is constrained by the forward link transmit power and forward link spreading code resources available for that CDMA channel signal.

As an example, a typical CDMA channel in an IS-2000 based network is allocated a maximum of twenty (20) Watts of transmit power and a maximum of sixty-four Walsh codes of 64-length. Some number of Walsh codes and some variable amount of the transmit power must be allocated to define “overhead” forward link channels, such as paging and common control channels. Therefore, the remaining power and code resources constrain the number of user traffic links that may be defined for a given CDMA channel. Each mobile station 22 that is admitted to the channel for service consumes one or more spreading codes and some variable amount of the available transmit power. If either power or coding resource is depleted out of proportion to the other, the channel will be utilized at less than its maximum capacity.

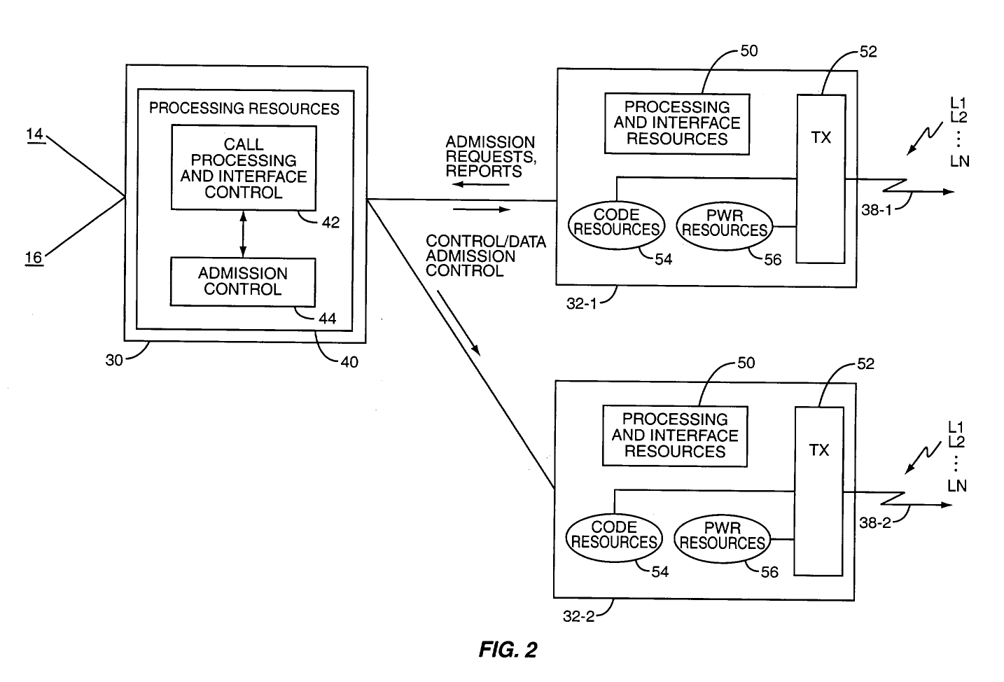

FIG. 2 illustrates exemplary BSC and RBS details, and provides a framework for explaining exemplary methods for considering the relative availabilities of power and code resources in new user admission control. The BSC 30 comprises processing resources that include call processing and interface control resources 42, and admission control resources 44. As is well understood by those skilled in the art, the specific implementation of the BSC 30 depends on its processing and switching architecture, but in an exemplary embodiment, the BSC's processing resources comprise one or more microprocessors and/or processing sub-systems, along with the necessary switching/routing resources and storage. Such storage may include, for example, disk storage and/or diskless storage such as non-volatile memory devices. Thus, the BSC 30 includes storage for computer and/or logic instructions supporting practice of the present invention and for supporting overall call processing operations.

An exemplary RBS 32 comprises processing and interface resources 50 and transmitter resources 52, which functionally include or are associated with coding resources 54 and transmitter power resources 56. Of course, the code resources 54 and power resources 56 do not necessarily represent physical entities within each RBS 32, but are graphically depicted herein to illustrate how such resources limit the number of users that may be supported on a given CDMA channel. Unless noted otherwise, one may assume that each CDMA channel is allocated its own code resources 54 and power resources 56. Thus, one may assume that “pairs” of assigned code resources 54 and power resources 56 are available for each CDMA channel transmitted by the illustrated RBSs 32. Of course, the invention may be practiced even where one or both power and code resources are shared among two or more CDMA channels,

In the illustration, each RBS 32 transmits at least one CDMA channel signal, i.e., RBS 32-1 transmits CDMA channel signal 38-1, and so on, and each CDMA channel signal 38 supports a variable number of “links,” L1 through LN, for supporting transmissions from the network 10 to one or more mobile stations 22. In an exemplary, embodiment, such links include the individual forward traffic channels used to serve individual ones of the mobile stations 22.

As noted earlier, the number of such links that may be supported by a given CDMA channel depends on several parameters. Such parameters include the maximum transmit power available for that channel, the total number of spreading codes available for code-multiplexing individual information streams onto the channel, and on the prevailing operating conditions, such as current radio conditions and user service characteristics (data rate/type, etc.). Regardless of the prevailing operating conditions, the number of links that may be supported by the CDMA channel signal 38 generally is increased if code resources 54 and power resources 56 are allocated on a substantially proportional basis as new users are admitted for service. In that manner, the network 10 does not disproportionately exhaust available transmit power or available spreading codes.

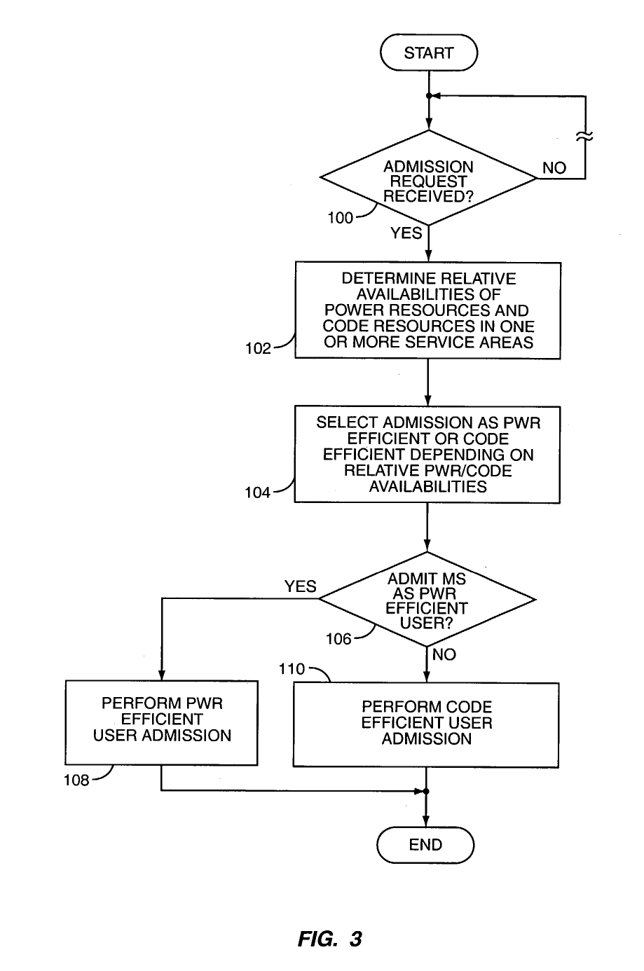

FIG. 3 illustrates a general method for practicing admission control in accordance with one or more exemplary embodiments of the present invention. As such, admission controller 44 in BSC 30 may be configured to perform such admission control on an ongoing basis during call admission operations at the RBSs 32. It should be understood that admission controller 44 might be implemented in hardware, software, or some combination thereof. Further, any data needed by the admission controller 44, such as configuration data, and current power/code availability values, is either stored in the BSC 30, or is available based on querying other network entities, or receiving timely reports (messages) from such entities.

For a particular mobile station 22, processing begins with BSC 30 receiving an admission request from the mobile station 22 (Step 100). Such requests are generally associated with one or more originating service areas as indicated by the particular RBS(s) 32 through which the admission request is received. (It should be noted the BSC 30 preferably performs concurrent tasks as needed while waiting for admission requests.)

In an exemplary embodiment, the BSC 30 determines the relative availabilities of code resources 54 and power resources 56 for at least one CDMA channel (Step 102). Where such a determination is made only for one CDMA channel, that channel usually is the one associated with the originating service area and thus is the channel that will be used to serve the mobile station 22. Where power/code resources are evaluated for more than one CDMA channel, the mobile station 22 may or may not be served from all such channels.

In expanding on this scheme, the BSC 30 may consider the relative availabilities of power/code resources in multiple RBSs 32 that correspond to the reported pilot signals in the mobile station's active set report. As an example of such operations, in an IS-2000 network supporting Call Admission into Soft Handoff (CASH), the BSC 30 may determine relative power/code resource availabilities at each RBS 32 that may be used to serve the mobile station 22 in soft handoff on the forward link.

Assuming sufficient power/code resources are available on at least one CDMA channel, BSC 30 admits the mobile station 22 as a power-efficient user or as a code-efficient user (Step 104). With insufficient power and/or code resources at all possible channels, admission of the mobile station 22 is blocked or at least deferred. In general terms, BSC 30 admits mobile station 22 as a power-efficient user if a current availability of code resources 54 exceeds a current availability of power resources 56, and admits mobile station 22 as a code-efficient user if the current availability of power resources 56 exceeds the current availability of code resources 54. Thus, if the mobile station 22 is selected for power-efficient admission (Step 106), BSC 30 configures the link(s) to be allocated to the newly admitted mobile station 22 for power-efficient operation (Step 108); otherwise, the BSC 30 configures the link(s) for code-efficient operation (Step 110).

In either case, implicit in the above logic is that power efficiency comes at the expense of coding efficiency, and vice versa. To better understand this tradeoff, it may be helpful to review selected aspects of CDMA coding. Generally, each CDMA channel signal 38 carries selected overhead channel signals, such as paging and common control channel signals, and carries an individual information stream for each mobile station 22 being supported on that CDMA channel signal 38. In IS-2000 systems, for example, the base spreading code set that may be used to spread individual information streams onto a CDMA channel comprises sixty-four Walsh codes of length 64. In a nominal case, three of these base codes are allocated to overhead channels, thus leaving sixty-one Walsh codes available for supporting individual users.

One technique for increasing code space is based on deriving two longer Walsh codes of length 128 from one or more of the 64-length Walsh codes in the base set. Theoretically, then, the code space increases from sixty-four codes to one hundred and twenty-eight codes. Since each short Walsh code maps into two distinct longer Walsh codes, the assignment of a given 128-length disallows the use of a parent 64-length Walsh code simultaneous with one or both its child 128-length codes. Therefore, the expanded code set supports fewer than one hundred and twenty-eight users since some of the 64-length codes must still be allocated to the overhead channels.

IS-2000 systems define several radio configurations, including RC3, which uses 64-length Walsh codes and thus consumes codes from the base code set as new RC3 users are admitted, and RC4, which uses 128-length Walsh codes and thus consumes codes from the expanded code set as new RC4 users are admitted. The tradeoff in power efficiency between RC3 and RC4 users results from changes in the convolutional encoding techniques applied to the user data stream.

With RC3, convolutional encoding of the individual information streams uses a one-to-four encoding rate that provides greater data redundancy than the one-to-two encoding rate used in RC4. With RC4's lowered redundancy, the signal strength requirements increase relative to RC3 for an equivalent received data error rate at the mobile stations 22. Thus, for equivalent channel conditions (loss, interference, noise, fading, etc.), RC4 users require higher transmit power than RC3 users. However, one sees that if network 10 selectively admits new users in either RC3 or RC4, it can maintain a desired balance between power and code resource allocations.

In another approach to gaining increased code space, the base code set may be expanded with the use of quasi-orthogonal codes. Such codes are not completely orthogonal to every other spreading code in the base code set and thus result in higher levels of Multi-User Interference (MUI). The increased MUI has the tendency to drive up the transmit power requirements of all active users on the affected CDMA channel signal 38, such that adding additional users through use of quasi-orthogonal codes increases code space at the expense of power efficiency. Thus, whether encoding rates and code lengths are varied, or whether orthogonal and quasi-orthogonal codes are used, the present invention contemplates configuring one or more transmit parameters associated with serving individual users such that each user may be admitted in a manner that favors power efficiency or coding efficiency.

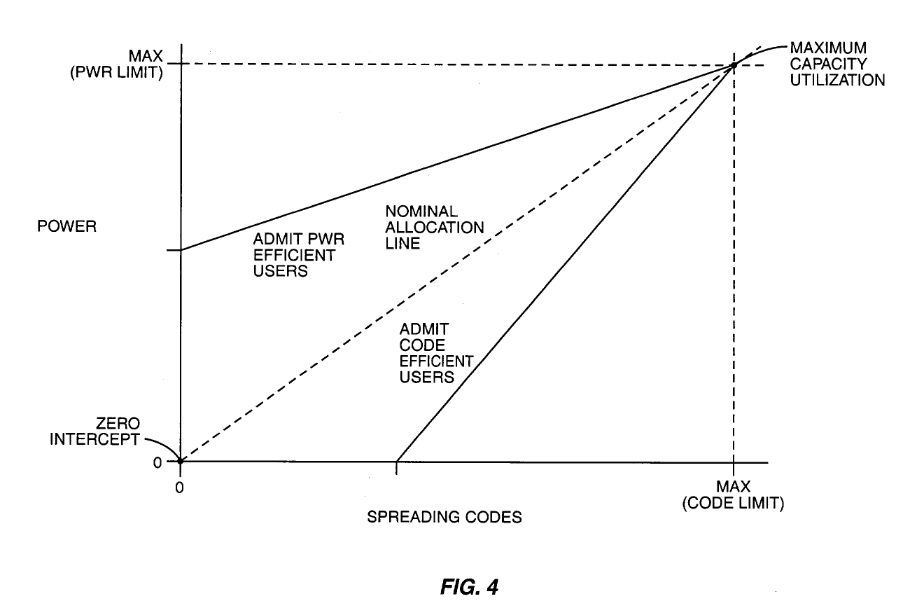

FIG. 4 graphically depicts power resource usage in relation to coding resource usage. The illustrated allocation lines may represent power/code allocations at a single RBS 32, or represent combined power/code allocations calculated for two or more RBSs 32. Thus, the depicted power/code allocation lines may represent combined allocations within a “neighborhood” of service areas. In any case, the nominal power/code allocation line runs from a (0,0) intercept of the power and code axes, and terminates at a point of maximum capacity utilization where both power and code resources are exhausted. In exemplary embodiments of the present invention, admission controller 44 performs admission control such that the ratio of power to code allocation (or availability) tends toward the nominal allocation line during operation.

Thus, in looking at selection/admission steps 102 and 104 of FIG. 3, the admission controller 44 receives availability reports from the RBSs 32 that provide the admission controller 44 with current power/code usage information for the sets of code resources 54 and power resources 56 at each RBS 32. In response to receiving an admission request from a mobile station 22, the admission controller 44 uses the current power/code resource availability information to determine whether the mobile station should be admitted as a power-efficient or as a code-efficient user, assuming that current resource availability allows the user to be admitted at all.

In one embodiment for IS-2000 networks, the admission controller 44 projects what the power/code allocation would be if the mobile station is admitted as a power-efficient user, and makes a similar projection based on admitting the mobile station as a code-efficient user. The admission controller 44 admits the mobile station 22 as either a power-efficient or a code-efficient user depending on which projection moved the overall power/code allocation closer to the nominal power/code allocation line. In a slightly simplified approach, admission controller 44 might simply admit the mobile station 22 as a code-efficient user if the current power/code allocation point is below the nominal allocation line or as a power-efficient user if the current power/code allocation point is above the nominal allocation line.

In Wireless Local Loop (WLL) applications, the RBSs 32 provide wireless service to fixed or very low-mobility communication devices rather than to mobile stations 22. In such scenarios, the likelihood of a given user moving from one network service area to another is relatively low. Thus, the power/code allocation(s) that are relevant to serving that user often are limited to the fixed service area of the user. In contrast, network 10 may wish to consider the power/code allocations among a set or neighborhood of service areas when admitting a mobile user, since there is at least some probability that the user will move among different service areas after admission to network 10.

In an approach that accommodates variable mobility, admission controller 44 may incorporate a mobility-based weighting factor into its admission calculations. With this scheme, admission controller 44 selects power-efficient or code-efficient admission based on the power/code allocations among a neighborhood of CDMA channels that will or might be used to serve the user being admitted to network 10.

The mobility-weighted admission scheme may be summarized as follows:

choose a weighting value ∂ representing the mobility of the system (note that this is configurable parameter);

calculate a combined power allocation value P that relates the power usage of a set of reference CDMA channels, with at least one channel in the set, in the neighborhood to the remaining channels in the neighborhood, where P is given as, P=∂P_{CH}+(1−∂)P_{T}, and where P_{CH}=the power usage of the reference channel(s) and P_{T}=the power usage for the remaining channels in the neighborhood;

calculate a combined spreading code allocation value C that relates the code usage of the reference channel(s) to the remaining channels in the neighborhood, where C=∂C_{CH}+(1−∂)C_{T}, and where C_{CH}=the code usage of the reference channel(s) and C_{T}=the code usage for the remaining channels in the neighborhood ; and

choose either power-efficient or code-efficient admission based on the following logic:

IF P<Pₜₕᵣₑₛₕ∥P>C)

select power-efficient user admission, e.g., RC3

Else

select code-efficient user admission, e.g., RC4

P_{T} may be calculated as the total power normalized by the total number of users for the remaining channels in the neighborhood, C_{T} may be calculated as the percentage allocation of base spreading codes for the remaining channels in the neighborhood, and Pₜₕᵣₑₛₕ may be set as an initial threshold for allocating power-efficient users when the CDMA channel(s) are lightly loaded. Also, note that in the above equations, the power and code values may be discounted by the power and code resources allocated to supporting the overhead channels. Thus, the values may be normalized based on the remaining code and power resources available for allocation to user traffic links.

The above admission control logic holds where there is a unique solution to the following problem:

2 * N₁+N₂=C1, and (1)

P₁N₁+P₂N₂=C2 (2)

Where N₁=equals the total number of base set spreading codes that would be used with admission of the new user, and N₂=the total number of extended spreading codes that would be used, and where P₁=the power consumed by the total number of N₁ users and P₂=the power consumed by the total number of N₂ users. In an IS-2000 implementation for example, (N₁, P₁)=(N_{RC3}, P_{RC3}) and (N₂, P₂)=(N_{RC4}, P_{RC4}). It should be noted that power allocation computations may be adjusted as needed where quasi-orthogonal codes are used to extend the base spreading code set to account for the increased MUI.

With the above admission method, admission controller computes combined power and code allocation values (P and C) for the neighborhood of CDMA channels, but applies a first weighting term ∂ to the reference channel or channels' power and code allocations, and a second weighting term (1−∂) to the remaining channels' power and code allocations. This approach allows admission controller 44 to give more or less weight to the neighborhood values in relation to the reference channel value based on the configurable mobility parameter. Note that the admission controller 44 may use different mobility values a for different users, or types of users.

In the above context, the set of reference channel generally is some subset of the neighborhood of channels. The set may include a single channel, such as the channel on which the admission request was received, or may include at least some of the channels identified in a radio environment report from the mobile station 22, particularly with admission into soft handoff. For example, where the user is being admitted into soft handoff, the set of reference channels may be designated based on which pilot signals are reported as the strongest in the desired active set of the mobile station 22.

On that point, it should be noted that “neighborhoods” as used herein may be dynamically defined for the particular user being admitted based on that user's reported active set, or may be statically defined based on expected mobility between service areas, such as two or more adjacent cells in a busy urban area, or some combination thereof. Indeed, even if the network 10 stores predefined neighborhoods, such definitions may be altered over time based on developing longer-term mobility statistics for the various service areas in the network 10.

By using the desired active sets from mobile stations 22 requesting admission, the number of RBSs 32 and/or BSCs 30 involved in the admission decision may be constrained to limit the inter-entity messaging, and thereby avoid excessive network signaling. With the active set approach, the network 10 considers power/code allocations among the service areas associated with the radio environment report from a particular mobile station 22 that desires admission for service. Each service area generally is served by at least one CDMA channel (multiple channels may be provided in a given service area where two or more CDMA carrier frequencies are available). Thus, active-set based admission preferably considers the power/code resource allocations for each of the CDMA channels associated with the desired active set.

Using the previously described admission control logic as a basis, power and code allocations for admitting a particular mobile station 22 may be calculated based on the active set report from that mobile station as follows:

$$\begin{matrix}P = \frac{( Pi + Pj + Pk + … + Pn )}{n} , \\ & ( 3 ) \\ C = \frac{( Ci + Cj + Ck + … + Cn )}{n} . & ( 4 )\end{matrix}$$

Where n=the total number of CDMA channels for the reported active set (preferably, n is limited to no more than six active set members), and where i, j, and k are member channels of the active set. In IS-2000 systems, the sum of spreading code usage (Walsh code allocations) may be obtained by 100/Walsh-length and may be provided per CDMA channel. In any case, within the above framework, the admission control decision becomes,

IF P<Pₜₕᵣₑₛₕ∥P>C)

select power-efficient user admission, e.g., RC3

Else

select code-efficient user admission, e.g., RC4

In implementing the above active-set based approach, the BSC 30 may query the CDMA channels in the active set for current power/code resource allocations, and the reported values may be averaged across the channel set. Averaging ensures that active set usage is weighted by the spreading code usage for each channel in the set. The power/code resource allocation values may be obtained by the BSC 30 based on querying the RBS(s) 32 supporting the CDMA channels in the mobile station's active set, and/or based on the most recently received availability reports from the RBSs 32.

In another exemplary variation on the admission control decision, admission controller may employ an admission control metric and/or may alter the nominal allocation line function to change its power/code intercept axis and thereby alter the targeted power/code allocation balance. Thus, if the current conditions, such as the current service scenario for active users, make it “easier” or more desirable to consume more power than spreading codes, the admission controller 44 might adjust an “intercept attribute” such that the nominal allocation line intercepts the power/code axes at (y,0), where “y” is a selected offset from zero along the spreading code axis of FIG. 4. Conversely, if current conditions make easier or more desirable to consume more spreading codes than power, the admission controller might adjust the intercept attribute so that the nominal allocation line intercepts the power/code axes at (0,u), where “u” is a selected offset from zero along the power axis of FIG. 4.

Generally, if the intercept attribute is negative, the nominal allocation line begins on the spreading code axis and user admission is biased toward admitting power-efficient users. If the intercept attribute is positive, the nominal allocation line begins on the power axis and user admission is biased toward admitting code-efficient users. Within this context, the admission controller 44 may use an “admission metric” as its basis for admission control. An exemplary admission metric is defined as a discrete value that ranges from [0, 1, . . . , 255], and wherein a value of “0” represents the need to admit the user as a power-efficient user, a value of “255” represents the need to admit the user as a code-efficient user, and a value of “127” represents “no preference.” Values between these points represent intermediate degrees of preference.

In broad terms, the admission metric's value represents whether the user would be blocked from admission as power-efficient user or a code-efficient user, and, if not, how far the resultant power/code allocation point would be from the nominal allocation line if the user is admitted. Where admission is based on evaluating power/code resource allocation in a neighborhood of CDMA channels, the admission metric may be computed by taking the average of the admission metrics computed for the set of channels.

In more detail, an exemplary metric-based admission control method may be based on the following logic for each CDMA channel being evaluated:

determine whether the user could be admitted as a power-efficient user, e.g., a RC3 user;

determine whether the user could be admitted as a code-efficient user, e.g., a RC4 user;

if neither power-efficient nor code-efficient admission is feasible, the channel lacks sufficient resources to support admission of the user in either configuration and should be eliminated from consideration;

if power-efficient admission but not code-efficient admission could be granted, set the admission metric=0;

if code-efficient admission but not power-efficient admission could be granted, set the admission metric=255;

if both power-efficient and code-efficient admissions are possible, compute a power allocation value as,

$$P = \frac{\frac{( {τ}_{1} + {τ}_{2} )}{2}}{( Soft Handoff Threshold )} , \qquad ( 5 )$$

where τ₁ and τ₂ represent calculated power-efficient and code-efficient forward power metric values such that P is a measure of power utilization based on the average of the two power metrics but normalized such that 100% represents the admission blocking threshold for soft handoffs;

further, if both power-efficient and code-efficient admission is possible, compute spreading code allocation as,

$$C = \frac{\frac{( {C}_{1} + {C}_{2} )}{2}}{s} \qquad ( 6 )$$

where C₁=the number of extended codes blocked or allocated for non-overhead channels if the user is admitted as a power-efficient user, C₂=the number of extended codes blocked or allocated for non-overhead channels if the user is admitted as a code-efficient user, and “s” represents the total number of codes available with the extended spreading code set discounted for those codes allocated to the overhead channels.

With respect to CDMA systems employing 64-length Walsh codes in the base code set and 128-length Walsh codes in the extended code set, such as is done in IS-2000 systems, the value s in (6) equals “121” where there are 128 extended codes available, with seven of them associated with supporting the overhead channels. In this context, then, C₁=the number of 128-length Walsh codes that would be blocked or allocated with RC3 admission of the user, and C₂=the number of 128-length Walsh codes that would be blocked or allocated with RC4 admission of the user.

Based on this metric-based approach, the admission controller 44 may compute the admission metric based on the following,

If the nominal allocation line intercept>=0, X=C and Y=P;

If the nominal allocation line intercept<0, X=P and Y=C.

With the above, the admission metric τ may be expressed as,

τ=127−70*(|intercept|*(1−Y)+Y−X)*(X+Y). (7)

If the calculated admission metric τ is less than or equal to 127, the user is admitted as a power-efficient user (RC3 in IS-2000 systems), and is otherwise admitted as a code-efficient user (RC4 in IS-2000 systems). Note that if any of the CDMA channels considered by the admission controller 44 returned a different admission preference than the selected power-efficient or code-efficient configuration, the resources are reconfigured for those channels. Further, if multiple CDMA carrier frequencies are considered in admission control, resources associated with carriers not chosen for admission are released for subsequent allocation.

In still other admission control variations, the admission controller 44 might adopt a more simplified approach to user admissions. For example, the admission controller 44 might admit a particular user based on evaluating,

min (remaining power resources, remaining code resources), (8)

where the remaining power and code resources may be based on combined neighborhood values, or on a single CDMA channel.

In another exemplary variation of the present invention, power/code resource usage is implicitly considered in the admission decision by considering the user's distance from the serving RBS(s) 32. The distance and/or the general radio conditions of each user may be determined from, for example, the Carrier-to-Interference (C/I) ratio reported by the user. In one embodiment, the C/I ratio for a mobile station 22 being admitted is compared to one or more threshold values. Thus, with this measure of received signal quality, admission control may admit the more distant users as power-efficient users, e.g., as RC3 users in IS-2000 systems, and admit the closer users as code-efficient users, e.g., as RC4 users in IS-2000 systems. In this manner, users having more favorable radio conditions are biased toward code-efficient admission, and users having less favorable radio conditions are biased toward power-efficient admission.

With the above variations on the admission control decision, the possible set of channels considered in the power/code allocation evaluations generally includes the CDMA channels that will have resources granted for serving the admitted user. However, the present invention permits narrower or wider sets of channels for inclusion in the admission control decision. For example, the following channels and channel sets represent possible choices for admission control:

a) only the channel or channels that would be granted to the user by admission control;

b) the channels requested of admission control (the subset of pilots reported in a Radio Environment Report that were selected by a soft handoff granting algorithm);

c) the channels corresponding to the full set of pilots in the Radio Environment Report from the user being admitted;

d) the channels for the neighbor list determined from the user's active set;

e) the full union of neighbor sets of members of the active set; or

f) the full set of channels provided by the Base Station System (BSS), which comprises one or more BSCs 30 and all supported RBSs 32.

With the above decision control choices on included channels, it is expected that choices (c) through (f) represent increasingly meaningful choices with increasing system mobility. In other words, as the expected mobility of a user increases, the span or range of channels that have relevance on the admission control decision increases because the likelihood is that the user retain the initially assigned admission configuration (power-efficient or code-efficient) as the user is handed-off from service area to service area. For example, if a channel in a relatively nearby service area was critically loaded in terms of power resources, that fact might be used to bias user admission in another service area toward power-efficient admissions even if resources will not be initially allocated for the user from that channel.

Whether the admission control decision considers one channel, two channels, or many channels, the present invention provides a basis for admitting users for service in a wireless communication network that tends to maintain a balanced use of finite power and coding resources. Such balance is maintained by admitting users based on evaluating the relative availabilities of forward link transmit power and spreading code resources on one or more CDMA channels. If current conditions indicate that power resources are more scarce or being consumed disproportionately to coding resources, the user is admitted as a power-efficient user, or as a code-efficient user if coding resources are disproportionately allocated. Thus, the above details describe exemplary methods and apparatus for practicing the present invention and should not be construed as limiting the invention; rather, the present invention is limited only by the following claims and the reasonable equivalents thereof.

What is claimed is:

1. A method of call admission in a wireless communication network comprising:
receiving an admission request from a mobile station;
determining relative availabilities of power and code resources on one or more forward link CDMA channels; and
admitting the mobile station for service as a power-efficient user or as a code-efficient user based on the relative availabilities of power and code resources such that neither power resources nor code resources are disproportionately consumed as mobile stations are admitted for service.

2. The method of claim 1, wherein admitting the mobile station as a power-efficient user or as a code-efficient user comprises selecting between first and second service configurations for the mobile station, wherein, under equivalent channel conditions, the first service configuration is more power-efficient and the second service configuration is more code-efficient.

3. The method of claim 2, wherein the network comprises an IS-2000 network, and wherein selecting between first and second service configurations for the mobile station comprises selecting either Radio Configuration 3 (RC3) or Radio Configuration 4 (RC4) for serving the mobile station.

4. The method of claim 3, wherein selecting between first and second service configurations for the mobile station comprises defining an admission threshold for either RC3 or RC4, and admitting the mobile station as either a RC3 or a RC4 user based on comparing a current ratio of power/code usage to the admission threshold.

5. The method of claim 4, further comprising dynamically updating the admission threshold based on current power and code resource availabilities on the one or more CDMA channels such that the admission threshold tracks changing service conditions.

6. The method of claim 1, further comprising reassigning previously admitted mobile stations from being power-efficient users to being code-efficient users or vice versa, as needed, to maintain a desired balance between power resource and code resource usage on the one or more CDMA channels.

7. The method of claim 1, wherein determining relative availabilities of power and code resources on one or more CDMA channels comprises determining a combined power/code usage ratio for a neighborhood of CDMA channels.

8. The method of claim 7, wherein determining a combined power/code usage ratio for a neighborhood of CDMA channels comprises computing weighted power usage and code usage values for the neighborhood of CDMA channels using one or more mobility-based weighting values.

9. The method of claim 8, wherein computing weighted power usage and code usage values for the neighborhood of CDMA channels using one or more mobility-based weighting values comprises:
computing first weighted power usage and code usage values for a first set of channels in the neighborhood of CDMA channels;
computing second weighted power usage and code usage values for the remaining channels in the neighborhood of CDMA channels; and
determining the current power/code usage as a combination of the first and second weighted power usage and code usage values.

10. The method of claim 9, further comprising weighting the first power and code usage values in inverse proportion to a system mobility value, and weighting the second power and code usage values in proportion to the system mobility value.

11. The method of claim 9, further comprising defining the first set of channels as at least including the CDMA channel associated with the admission request.

12. The method of claim 9, further comprising defining the first set of channels based on at least a subset of the CDMA channels identified in a radio environment report from the mobile station.

13. The method of claim 7, further comprising defining the neighborhood of CDMA channels based on an originating service area of the mobile station and configured network data.

14. The method of claim 7, further comprising defining the neighborhood of CDMA channels based on an active set report from the mobile station.

15. The method of claim 1, wherein determining relative availabilities of power and code resources on one or more CDMA channels comprises determining available forward link transmit power and available forward link spreading codes at one or more Radio Base Stations (RBSs) that provide the one or more CDMA channels.

16. The method of claim 1, wherein admitting the mobile station for service as a power-efficient user or as a code-efficient user based on the relative availabilities of power and code resources comprises determining one or more admission metrics that indicate whether power or code-efficient admission of the mobile station would move current power/code usage closer to a nominal power/code usage line.

17. The method of claim 1, wherein admitting the mobile station for service as a power-efficient user or as a code-efficient user based on the relative availabilities of power and code resources comprises admitting the mobile station as a power-efficient user if the relative availability of power resources is less than the relative availability of code resources, or admitting the mobile station as a code-efficient user if the relative availability of code resources is less than the relative availability of power resources.

18. The method of claim 1, further comprising admitting mobile stations for service as power-efficient or code-efficient users based on reception conditions for the mobile stations.

19. The method of claim 16, wherein admitting mobile stations for service as power-efficient or code-efficient users based on reception conditions for the mobile stations comprises admitting a mobile station as a code-efficient user if a carrier-to-interference (C/I) ratio for the mobile station is at or above a threshold value, and admitting the mobile station as a power-efficient user if the C/I ratio is below a threshold value.

20. The method of claim 1, wherein admitting the mobile station for service as a power-efficient user or as a code-efficient user based on the relative availabilities of power and code resources further comprises additionally considering a carrier-to-interference (C/I) ratio for the mobile station, such that the admission decision is biased toward power-efficient user admission if the C/I ratio is below a threshold value.

21. A Base Station Controller (BSC) for use in a wireless communication network comprising:
call processing resources including a Radio Base Station (RBS) interface for communicating with one or more RBSs; and
an admission controller configured to perform call admissions based on:
receiving an admission request from a mobile station;
determining relative availabilities of power and code resources on one or more CDMA channels; and
admitting the mobile station for service as a power-efficient user or as a code-efficient user based on the relative availabilities of power and code resources such that neither power resources nor code resources are disproportionately consumed as mobile stations are admitted for service.

22. The BSC of claim 21, wherein the BSC admits the mobile station as a power-efficient user or as a code-efficient user by selecting between first and second service configurations for the mobile station, wherein, under equivalent channel conditions, the first service configuration is more power-efficient and the second service configuration is more code-efficient.

23. The BSC of claim 22, wherein the BSC operates in an IS-2000 network, and wherein the BSC selects between first and second service configurations for the mobile station by selecting either Radio Configuration 3 (RC3) or Radio Configuration 4 (RC4) for serving the mobile station.

24. The BSC of claim 23, wherein the BSC selects between first and second service configurations for the mobile station by defining an admission threshold for either RC3 or RC4, and admitting the mobile station as either a RC3 or a RC4 user based on comparing a current ratio of power/code usage to the admission threshold.

25. The BSC of claim 24, wherein the BSC dynamically updates the admission threshold based on current power and code resource availabilities in the one or more service areas such that the admission threshold tracks changing service conditions at the one or more RBSs.

26. The BSC of claim 21, wherein the BSC reassigns previously admitted mobile stations from being power-efficient users to being code-efficient users or vice versa, as needed, to maintain a desired balance between power resource and code resource at Radio Base Stations (RBSs) providing the one or more CDMA channels.

27. The BSC of claim 21, wherein the BSC determines relative availabilities of power and code resources on the one or more CDMA channels by determining a combined power/code usage ratio for a neighborhood of CDMA channels.

28. The BSC of claim 27, wherein the BSC determines a combined power/code usage ratio for a neighborhood of CDMA channels by computing weighted power usage and code usage values for the neighborhood of CMDA channels using one or more mobility-based weighting values.

29. The BSC of claim 28, wherein the BSC computes weighted power usage and code usage values for the neighborhood of CDMA channels using one or more mobility-based weighting values based on:
computing first weighted power usage and code usage values for a first set of channels in the neighborhood of CDMA channels;
computing second weighted power usage and code usage values for the remaining channels in the neighborhood of CDMA channels; and
determining the current power/code usage as a combination of the first and second weighted power usage and code usage values.

30. The BSC of claim 29, wherein the BSC weights the first power and code usage values in inverse proportion to a system mobility value, and weights the second power and code usage values in proportion to the system mobility value.

31. The BSC of claim 29, wherein the BSC defines the first set of channels as at least including the CDMA channel associated with the admission request.

32. The BSC of claim 29, wherein the BSC defines the first set of channels based on at least a subset of the CDMA channels identified in a radio environment report from the mobile station.

33. The BSC of claim 27, wherein the BSC defines the neighborhood of CMDA channels based on an originating service area of the mobile station and configured network data.

34. The BSC of claim 27, wherein the BSC defines the neighborhood of CDMA channels based on an active set report from the mobile station.

35. The BSC of claim 27, wherein the BSC determines relative availabilities of power and code resources on the one or more CMDA channels by determining available forward link transmit power and available forward link spreading codes at one or more Radio Base Stations (RBSs).

36. The BSC of claim 21, wherein the BSC determines relative availabilities of power and code resources on one or more CDMA channels by determining available forward link transmit power and available forward link spreading codes at one or more Radio Base Stations (RBSs).

37. The BSC of claim 21, wherein the BSC admits the mobile station for service as a power-efficient user or as a code-efficient user based on the relative availabilities of power and code resources by determining one or more admission metrics that indicate whether power or code-efficient admission of the mobile station would move current power/code usage for the one or more CDMA channels closer to a nominal power/code allocation line.

38. The BSC of claim 21, wherein the BSC admits the mobile station for service as a power-efficient user or as a code-efficient user based on the relative availabilities of power and code resources by admitting the mobile station as a power-efficient user if the availability of power resources is less than the availability of code resources, or by admitting the mobile station as a code-efficient user if the availability of code resources is less than the availability of power resources.

39. The BSC of claim 21, wherein the BSC admits the mobile station for service as a power-efficient user or as a code-efficient user further based on a carrier-to-interference (C/I) ratio for the mobile station, such that the admission decision is biased toward power-efficient user admission if the C/I ratio is below a threshold value.
